(19) United States
(12) Patent Application Publication
(10) Pub. No.: US 2026/0204967 A1
(43) Pub. Date: Jul. 16, 2026

(54) ROTOR AND ELECTRICAL MACHINE

(71) Applicant: MAHLE International GmbH, Stuttgart (DE)

(72) Inventor: Philipp Licht, Stuttgart (DE)

(21) Appl. No.: 19/134,693

(22) PCT Filed: Oct. 23, 2023
(86) PCT No.: PCT/EP2023/079490

§ 371 Date: May 30, 2025

(30) Foreign Application Priority Data
Dec. 2, 2022 (DE) 10 2022 213 027.8

(51) Int. Cl. H02K 1/32; H02K 7/00; H02K 7/04

(52) U.S. Cl. CPC H02K 1/32; H02K 7/003; H02K 7/04

(57) ABSTRACT

A rotor of an electric machine is disclosed. The rotor includes a hollow shaft that has a first cooling channel for a cooling medium. A laminated core is arranged on the hollow shaft. A balancing disc is arranged on a longitudinal end side of the laminated core. A component of an injection molding compound/molding compound is arranged between the balancing disc and the laminated core. The component comprises at least one second cooling passage open in an axial direction and communicating with the first cooling passage in the hollow shaft, and is covered in an axial direction by the balancing disc and forms an at least partially closed cooling passage.

### CROSS-REFERENCE TO RELATED APPLICATIONS

This application claims priority to International Patent Application No. PCT/2023/079490 filed Oct. 23, 2023, which also claims priority to German Patent Application No. DE 10 2022 213 027.8 filed Dec. 2, 2022, the contents of each of which is hereby incorporated by reference in its entirety.

### TECHNICAL FILED

The present invention relates to a rotor of an electric machine with a hollow shaft having a first cooling channel for a cooling medium. The invention also relates to an electric motor, in particular a traction motor, with such a rotor.

### BACKGROUND

DE 10 2015 014 535 A1 discloses a generic rotor of an electric machine with a hollow shaft that has a first cooling channel for a cooling medium. A lamella package is arranged on the hollow shaft, at the axial longitudinal end of which a balancing disc is arranged to compensate for any imbalance that may occur.

U.S. Pat. No. 8,450,890 B2 discloses a further rotor of an electric machine with a rotor shaft having a first cooling channel.

The increasing number of electric vehicles also means that an increasing number of electric traction motors are needed to drive these electric vehicles. Such electric motors must be optimized in terms of weight and installation space while also being powerful. For this reason, it is common practice to actively cool such electric motors, for example by means of oil cooling. If this is not done, the rotor windings through which a pathogen current flows can become very hot during operation, leading to a loss of power in the electric motor. In addition, dynamic operating conditions in particular cause magnetic field changes that generate eddy currents in the rotor, meaning that even the magnets provided in the rotor of permanently excited machines may require active cooling to maintain their function.

However, a disadvantage of the rotors and electric motors known from the prior art is that the production of cooling medium, i.e., usually oil, leading cooling channels is not only technically complex and therefore expensive, but often also requires axial installation space that is either not available or can only be created by accepting a lower power output. In addition, with conventional rotors and electric motors, it is difficult or impossible to cool the winding heads of the rotor windings, PSM magnets (permanently excited synchronous machines), or stator winding heads.

The present invention therefore addresses the problem of providing an improved or at least alternative design for a rotor of the generic type, which is characterized in particular by cooling channels that are easy to manufacture and also compact in the axial direction.

According to the invention, this problem is solved by the object of the independent claim(s). Advantageous embodiments are the subject of the dependent claims.

### SUMMARY

The present invention is based on the general idea of equipping a rotor of an electric machine with multi-shell cooling channels, which significantly simplifies their manufacture, as they no longer need to be produced by drilling or milling. The first shell of such a cooling channel is formed by an injection molding compound/casting compound, which covers, for example, rotor windings (separately excited synchronous machine) or PSM magnets of the rotor, in which an open, demoldable cooling channel can be formed cost-effectively and with high precision using a suitably designed injection molding tool/overmolding tool/casting tool. The plastic injection molding tool is used to overmold the longitudinal ends of the rotor windings or PSM magnets, thereby also providing electrical insulation. A second shell of the cooling channel is formed by an easy-to-manufacture balancing disc, which merely covers the cooling channel in the component manufactured from the injection molding compound/casting compound. This completely eliminates the need for time-consuming drilling and/or milling. The rotor of an electric machine according to the invention, for example a traction motor in an electric vehicle, has a hollow shaft which has a first cooling channel for a cooling medium, for example oil. A laminated core with individual rotor plates is arranged on the hollow shaft, with a balancing disc arranged on the rotor shaft at least one longitudinal end of the laminated core in order to compensate for any imbalance. According to the invention, a component made of an injection molding compound/casting compound is now arranged between this balancing disc and the laminated core, which component has at least one second cooling channel that is initially open in the axial direction and thus easy to remove from the mold and is connected to the first cooling channel in the hollow shaft, which second cooling channel is covered in the axial direction by the balancing disc and is thus closed. The component made from the injection molded compound/casting compound and the balancing disc thus form the two shells for the second cooling channel. The major advantage of this solution is that the at least one second cooling channel can be produced relatively easily and cost-effectively using a corresponding negative mold of a plastic injection mold/overmolding tool/casting mold. Thanks to the at least one second cooling channel open in the axial direction in the component, it is not only comparatively easy to manufacture, but also comparatively easy to rework if necessary. The second cooling channel formed in the component in a channel-like manner is closed off in the axial direction by the balancing disc, which allows for a comparatively flexible, simple to manufacture, and cost-effective design of the at least one second cooling channel.

It goes without saying that the injection molding compound/casting compound can be made of plastic and therefore electrically insulating.

In an advantageous further development of the rotor according to the invention, the component is conically shaped. The component can also be designed in a ring shape and, when installed, leave a ring-shaped intermediate space between an outer jacket surface of the hollow shaft and the component. The conical design of the component makes it relatively easy to implement a wide variety of channel geometries for the at least one second cooling channel. The component may have an axial thickness that increases radially outward, so that in this case the associated balancing disc has an axial thickness that decreases radially outward in this area. Of course, a non-conical design of the component, for example stepped or with a radially outwardly constant axial thickness, is also conceivable.

The component manufactured according to the invention as a casting component or injection molded component allows the second cooling channels to be produced with high geometric flexibility and low costs, since they only need to be milled once in a corresponding injection mold. This eliminates the need to separately insert, for example, the second cooling channels forming bores into the balancing disc for each individual balancing disc.

In another advantageous embodiment of the rotor according to the invention, rotor windings with winding heads on the longitudinal end side are arranged in the laminated core and embedded in the injection molding compound/casting compound of the component. This allows direct cooling of these winding heads by means of an appropriate arrangement or design of the at least one second cooling channel in the component, whereby improved cooling of the rotor windings, and thus increased performance of a separately excited synchronous machine, can be achieved. In this case, the cooling medium sprayed outwards can be used to cool the stator windings or stator winding heads of an externally excited synchronous machine. Alternatively, it is also conceivable that PSM magnets are arranged in a laminated core on the hollow shaft, with the PSM magnets being embedded in the injection molded compound/casting compound of the component at their longitudinal ends, among other places. The PSM magnets can be held or fixed in place using the injection molding compound/casting compound of the component. The cooling medium sprayed outwards can also be used to cool stator windings or stator winding heads of a permanently excited synchronous machine.

In a particularly preferred embodiment of the rotor according to the invention, the at least one second cooling channel has a constant or variable cross-section. In addition or alternatively, it can also be linear or curved. This non-exhaustive list alone gives an idea of the diverse and extremely flexible options available for designing the channel geometry and channel cross-section in the rotor according to the invention. This allows different cooling medium flows to be individually controlled.

Furthermore, in addition or alternatively, the at least one second cooling channel may be closed or open radially outward. With a radially outward opening design, additional cooling of surrounding components is also possible, while with a radially outward closed design, improved cooling of the rotor windings or PSM magnets can be achieved.

In another advantageous embodiment of the rotor according to the invention, a balancing disc and a component made of an injection-molded compound/casting compound are arranged at both longitudinal ends of the laminated core, which each have at least one second cooling channel that is open in the axial direction and connected to the first cooling channel in the hollow shaft, which is covered in the axial direction by the associated balancing disc. By providing at least one second cooling channel at each longitudinal end of the laminated core, it is possible to further improve the cooling of the rotor, in particular at the opposing winding heads of the rotor windings or the longitudinal ends of the PSM magnets and thus of the PSM magnets themselves, thereby increasing the performance of an electric motor equipped with such a rotor. In this context, a direct communicating connection between every second cooling channel and the first cooling channel arranged in the hollow shaft is conceivable, or alternatively a supply of cooling medium, in particular cooling oil or gear oil, via only a second cooling channel or a connecting channel connecting these two second cooling channels. A connection between the first and second cooling channels or between the first cooling channel and the connecting channel is usually made via a bore or longitudinal opening in the hollow shaft.

It is advantageous to arrange at least one connecting channel between the at least two opposing second cooling channels or between the two opposing intermediate spaces. A cooling medium can be supplied to both opposing second cooling channels via such a connecting channel, or a cooling medium can be supplied from the one second cooling channel/intermediate space on the one longitudinal side to the opposing second cooling channel/intermediate space on the other longitudinal side.

The connecting channel can run in the laminated core or between it and the hollow shaft. The connecting channel can also be connected directly to the first cooling channel in the hollow shaft by means of a radial channel. When the connecting channel is arranged in the laminated core, particularly effective cooling of the rotor windings or the magnets arranged in the laminated core (PSM magnets) is possible. For this purpose, corresponding longitudinal through-openings can be provided in the laminated core to form the connecting channel. If the connecting channel is arranged between the laminated core and the outer jacket surface of the hollow shaft, the connecting channel can be provided as a groove on an inner jacket surface of the laminated core and also extend in the longitudinal direction.

The balancing disc is conveniently made of metal, in particular aluminum or stainless steel. Alternatively, it is also conceivable that the balancing disc is made of plastic and has recesses for receiving balancing weights. Thanks to its aluminum or stainless steel construction, the balancing disc can be made relatively thin in the axial direction due to its higher weight compared to plastic, resulting in a particularly compact design in the axial direction.

In another advantageous embodiment of the solution according to the invention, the injection molding compound/casting compound is made of plastic. This not only makes the component relatively easy to manufacture and weight-optimized, but also creates an electrical insulator that separates the winding heads of the rotor windings or the PSM magnets from the balancing disc, especially if it is made of metal.

The present invention is further based on the general idea of equipping an electric machine, in particular a traction motor, with a rotor corresponding to the previous paragraphs and thereby transferring the advantages described with respect to the rotor to the electric machine. Specifically, these advantages lie in the comparatively compact design of the electric motor in the axial direction and in a manufacturing method that is both simple and cost-effective.

In an advantageous embodiment of the electric machine according to the invention, the stator windings have winding heads which are cooled by the cooling medium emerging from the second cooling channels. In this case, PSM magnets would be arranged in the laminated core of the rotor. It is therefore a permanently excited synchronous machine. Alternatively, however, rotor windings (exciter windings) may also be present, making it an externally excited synchronous machine.

Further important features and advantages of the invention are apparent from the dependent claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention. The above-mentioned components of a superordinate unit, such as a device, an apparatus, or an arrangement, which are designated separately, can form separate parts or components of this unit or be integral areas or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

They show, each schematically,

FIG. 1 is a sectional view through a rotor according to the invention in a first embodiment,

FIG. 2 is a representation as in FIG. 1, but with at least one connecting channel,

FIG. 3 is a representation as in FIG. 2, but with at least one connecting channel arranged between a laminated core and an outer jacket surface of a hollow shaft,

FIG. 4 is a representation as in FIG. 2, but with a different flow pattern, starting in the center of the hollow shaft between the ends of the laminated core,

FIG. 5 is a front view of a component with different second cooling channels and without a balancing disc,

FIG. 6 is a detailed view of the component with a constant and linear second cooling channel,

FIG. 7 is a view as in FIG. 5, but with a further modification of the second cooling channel,

FIG. 8 is a view of another possible embodiment of the component with a collar,

FIG. 9 is a sectional view through a rotor according to the invention with a component according to FIG. 8,

FIG. 10 is a sectional view as in FIG. 9, but in a different sectional plane,

FIG. 11 is a sectional view as in FIG. 10, but with a coolant flow.

### DETAILED DESCRIPTION

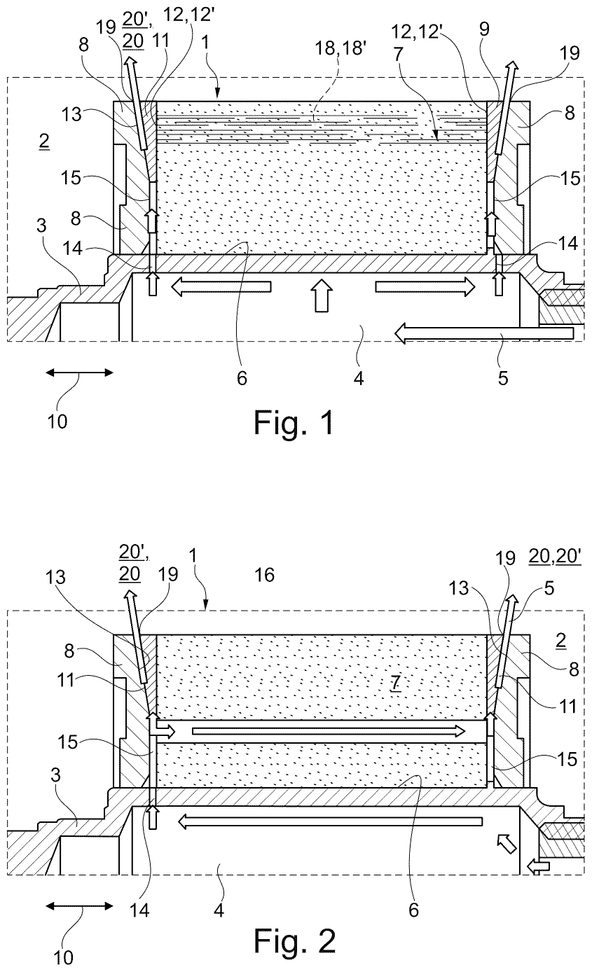

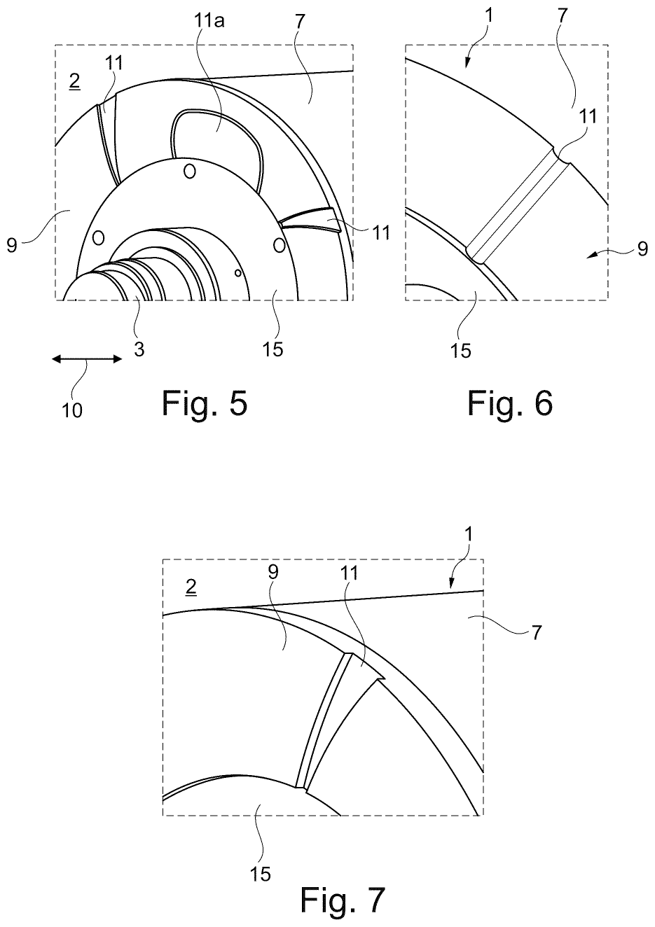

According to FIGS. 1 through 4, a rotor 1 of an electric machine 2, for example a traction motor of an electric vehicle not shown, according to the invention has a hollow shaft 3 which comprises a first cooling channel 4 for a cooling medium 5. The cooling medium 5 can be cooling oil or gear oil, for example. A laminated core 7 with unspecified sheet metal discs is arranged on an outer jacket surface 6 of the hollow shaft 3. Two balancing discs 8 are arranged on the longitudinal end side of the laminated core 7 to compensate for any imbalances in the rotor 1. Of course, a rotor 1 with only one such balancing disc 8 is also conceivable. According to the invention, a component 9 (see also FIGS. 5 through 8) made of an injection-molded compound/casting compound is now arranged between the balancing disc 8 and the laminated core 7, which has at least one second cooling channel 11 (see in particular FIGS. 5 through 7) which is open in the axial direction 10 and communicates with the first cooling channel 4 in the hollow shaft 3, which is covered in the axial direction 10 by the balancing disc 8 and forms a closed cooling channel. The cooling medium 5 can flow through corresponding outlet openings 19 to the stator windings or stator winding heads 20′ and cool them. The outlet openings 19 cause the cooling medium 5 to be sprayed outwards in a substantially radial and/or oblique or axial direction. Component 9 encloses winding heads 12 of the rotor windings 18 arranged on the longitudinal end side of the laminated core 7 and at the same time insulates them electrically. The winding heads 12 serve to deflect a winding wire, for example a copper wire, and to electrically connect an unspecified rotor winding 18. This is therefore an externally excited synchronous machine.

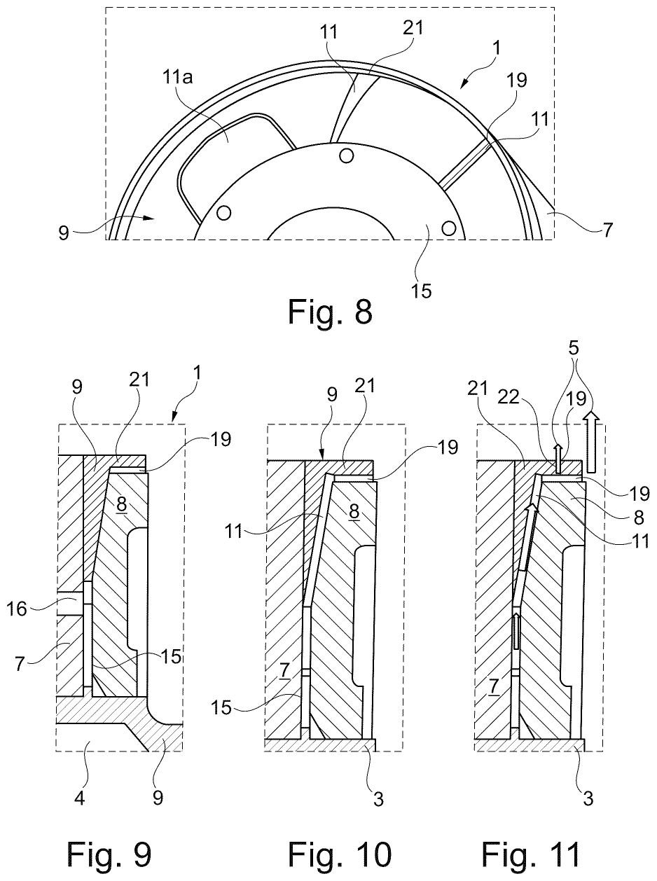

In general, the outlet openings 19 can be open in the radial direction (see FIGS. 1 through 7 and openings 22 in FIG. 11), but also in the axial direction, as shown, for example, in FIGS. 8 through 11. The opening 22 can be aligned in a radial direction or at an angle to the axis of the rotor 1.

Alternatively, it is also conceivable that PSM magnets 18′ are arranged in the laminated core 7 on the hollow shaft 3, wherein the PSM magnets 18′ are embedded at their longitudinal ends 12′ in the injection molding compound/casting compound of the component 9. The PSM magnets 18′ can be held or fixed in place using the injection molding compound/casting compound of component 9. In this case, the cooling medium 5 can flow through corresponding outlet openings 19 to the stator winding heads 20′ and cool them. This is therefore a permanently excited synchronous machine. PSM magnets 18′ can contain permanent magnet materials known in the trade, e.g., rare earth metals such as NdFeB.

Thus, at least one rotor winding 18 (in the case of a separately excited synchronous machine) or permanent magnets 18′ (in the case of a permanently excited synchronous machine) to be supplied with direct current is arranged on rotor 1 as an exciter winding. In both cases, the stator has several stator windings with stator winding heads 20′ that are fed with alternating current to generate a rotating magnetic field.

Through the component 9 according to the invention, with which the winding heads 12 or longitudinal ends 12′ of the PSM magnets 18′ are overmolded or cast, it is possible for the first time to produce a channel geometry of at least one second cooling channel 11 simply and yet with high quality by means of a plastic injection molding tool/casting tool/overmolding tool used to manufacture component 9, wherein the at least one second cooling channel 11 is formed in component 9 merely in the manner of a channel or a groove, and is only covered and thus closed in a channel-like manner by the attachment of the balancing disc 8. The major advantage of such a multi-shell second cooling channel 11 is that virtually any cooling channel geometry and virtually any cross-section can be achieved relatively easily, which was not possible with the second cooling channels previously used, for example, in the balancing disc 8, which had to be drilled. Furthermore, with the component 9 provided according to the invention, it is also not necessary to machine each balancing disc 8 to create the second cooling channels 11, since these can be provided as a negative mold by the injection molding tool or overmolding tool for manufacturing the component 9. The production of such a second cooling channel 11 therefore requires only a single machining operation on the tool, which is significantly simpler and more cost-effective than individual machining of each balancing disc 8, as was necessary for the production of previous cooling channels.

The injection/casting compound of component 9 can be injected through the laminated core 7 so that both end components 9 are connected to each other via corresponding webs that run through the laminated cores 7, and component 9 consists of a single casting, i.e., it is a single piece.

Looking at the cross-sectional views through rotor 1 in FIGS. 1 through 4, it can be seen that component 9 is conical in shape and has an axial thickness that increases radially outwards. In the same way, a complementary bevel 13 is arranged on the balancing disc 8. Of course, a non-conical design of component 9 is also conceivable, for example stepped or with a radially outwardly constant axial thickness.

By designing the injection mold or overmolding tool accordingly, it is possible to give the second cooling channel 11 a constant cross-section and, for example, a linear course, as shown in FIG. 6. According to FIG. 6, the second cooling channel 11 has a channel-shaped design. Alternatively, the second cooling channel 11 may also have a variable cross-section, as shown in the second cooling channel 11 according to FIG. 7 and corresponding to FIG. 5. The second cooling channel 11 shown in FIG. 7 also has a curved path. It is also possible to design the second cooling channel 11 as closed radially outward, as shown with reference number 11a in FIG. 5, or open radially outward, as shown with reference number 11. A second cooling channel 11a, which is closed radially toward the outside, has the advantage that one end face of the rotor and, via this, for example, the rotor winding heads or the PSM magnet 18′ can be cooled more effectively.

Looking at FIGS. 8 through 11, it can be seen that component 9 has a collar 21 that at least partially surrounds it on the outside. The collar 21 of component 9 can surround the balancing disc 8 so that the outlet opening 19 points in the axial direction. The second cooling channel 11 is formed in the area of the collar 21 by the latter and an outer jacket surface of the balancing disc 8 and has an axial section there. The cooling medium 5 can thus escape in the axial direction. Due to the centrifugal force, it now strikes axially offset (see FIG. 11) and can thus cool other areas, e.g., stator winding heads 20′ that protrude further over the laminated core 7. It is also conceivable here that the collar 21 has at least one opening 22 or does not run completely around, but has openings through which part of the cooling medium 5 can escape in the same way as the component according to, for example, FIG. 5, i.e., in the manner described above, without axial displacement, so that the cooling medium 5 is distributed better overall in the stator.

While the second cooling channels 11, which extend radially outward, conduct the cooling medium 5 to the stator winding heads 20′, they may not absorb enough heat from the rotor 1, which also generates heat loss (eddy current losses due to field asymmetries and fluctuations, and, in the case of external excitation, also winding and, if applicable, rectifier losses). This problem is solved by channels 11a (see FIG. 5), which are not open radially outward and carry cooling medium 5 to better cool rotor 1.

This non-exhaustive list or illustration alone gives an idea of the wide variety of cross-sectional geometries and configurations that are conceivable for the second cooling channel 11, wherein the respective shape can be produced with only a single machining operation on the injection mold or overmolding tool.

Looking further at FIG. 1, it can be seen that two through-openings 14 are arranged in the hollow shaft 3, via which the respective second cooling channel 11 is connected in communication with the first cooling channel 4 in the hollow shaft 3 and via which the respective second cooling channel 11 is supplied with cooling medium 5.

In FIG. 2, only a single through-opening 14 is provided, through which cooling medium 5 is fed directly into the left-hand second cooling channel 11. However, this is due to the sectional view representation, so that several such through-openings 14 are usually arranged distributed around the circumference. In the embodiment shown, component 9 is ring-shaped, leaving an intermediate space 15 in the radial direction between component 9 and the outer jacket surface 6 of the hollow shaft 3. Component 9 extends over the length of the rotor 1, wherein the injection molding compound/casting compound is injected through receptacles for the rotor windings 18 or the PSM magnets 18′ (magnet pockets) so that it is injected on the left, for example, and exits again on the right. In accordance with FIGS. 2 through 4 and 9, at least one connecting channel 16 is arranged between the two cooling channels 11 and between the two intermediate spaces 15, which passes through the laminated core 7 so that the cooling medium 5 flowing through the through-opening 14 from the first cooling channel 4 in the hollow shaft 3 into the intermediate space 15 is divided between the second cooling channel 11 and the connecting channel 16. On the right side, the cooling medium 5 enters the connecting channel 16 into the intermediate space 15 there, and from there continues radially outward via the second cooling channel 11.

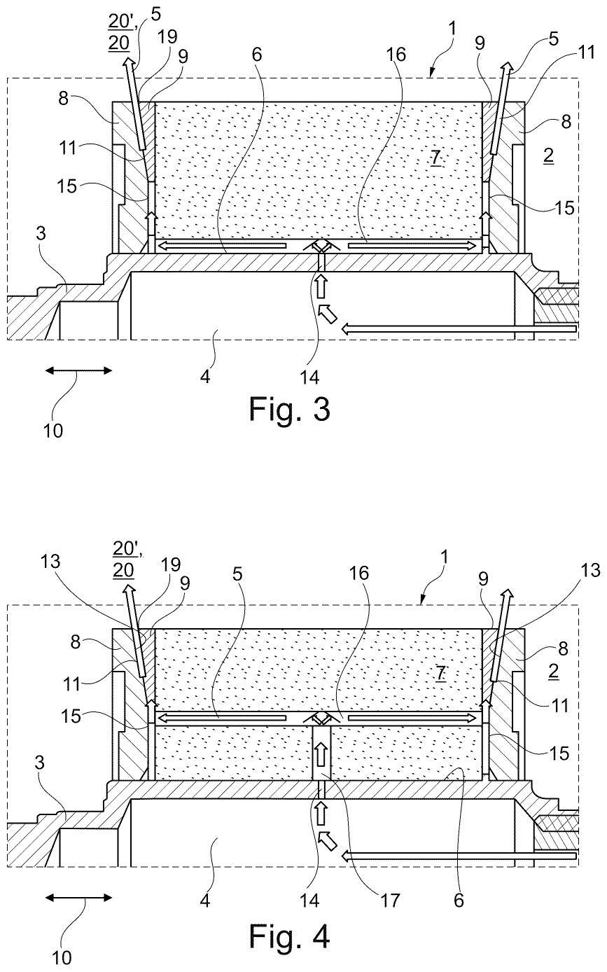

In accordance with FIG. 3, such a connecting channel 16 is also provided, but it is formed as a groove on an inner jacket surface of the laminated core 7 and is covered on the other side by the outer jacket surface 6 of the hollow shaft 3. In this case, the connecting channel 16 runs between the laminated core 7 and the outer jacket surface 6 of the hollow shaft 3. Cooling medium 5 is supplied via the through-opening 14, for example a bore, directly into the connecting channel 16 and from there in both axial directions 10 into the respective intermediate spaces 15 or the respective second cooling channels 11. The intermediate space 15 forms part of the respective second cooling channel 11.

In the embodiment shown in FIG. 4, a connecting channel 16 is also provided, but this is arranged in the same way as the connecting channel 16 shown in FIG. 2 with regard to its radial height. Cooling medium 5 is fed into the connecting channel 16 via a connecting channel section 17, which is connected on one side to the first cooling channel 4 via the through-opening 14 and on the other side to the connecting channel 16. This allows, for example, a particularly uniform supply of cooling medium 5 to the two opposing second cooling channels 11 compared to the embodiment of the rotor 1 according to the invention shown in FIG. 2.

The first cooling channel 4 is connected directly to at least one second cooling channel 11 or an associated intermediate space 15, as shown in FIG. 2, and, as shown in FIG. 2, to the left second cooling channel 11 or intermediate space 15 and indirectly via the connecting channel 16 with at least one opposite second cooling channel 11, here the right cooling channel 11 or the right intermediate space 15.

According to the embodiments shown in FIGS. 3 and 4, the first cooling channel 4 communicates exclusively directly with the connecting channel 16 and indirectly with the at least two second cooling channels 11 via the latter.

All embodiments have in common that at least one through-opening 14 is provided in the hollow shaft 4 for communicating connection with the respective intermediate space 15 or second cooling channel 11 or the channel section 17. These through-openings 14 can, for example, be designed as bores.

The balancing disc 8 used can be made of metal, in particular aluminum or stainless steel, and therefore requires only a low axial height due to its weight. Together with the arrangement of the second cooling channel 11 between the balancing disc 8 and the laminated core 7, a particularly compact design of the rotor 1 in the axial direction 10 can be achieved. By varying the design or arrangement and number of the second cooling channels 11, particularly effective and individually controllable cooling of the rotor 1, specifically of the winding heads 12 or the longitudinal ends 12′ of the PSM magnets 18′, can also be achieved, thereby increasing the performance of an electric machine 2 equipped with such a rotor 1.

An axial distance remains between the respective balancing disc 8 and the laminated core 7, forming the intermediate space 15, so that direct contact between the balancing disc 8 and the laminated core 7 is preferably avoided. Since component 9 is made from an injection molded compound/casting compound, preferably plastic, it is even possible to make the balancing disc 8 from metal, since component 9 forms an electrical insulator in this case.

Irrespective of the selected or described embodiments, the rotor 1 according to the invention can be used to achieve a particularly compact design of the rotor 1 in the axial direction 10, as well as particularly effective cooling of the same, whereby an electric machine 2 equipped with it is not only compact in design, but also powerful.

1. A rotor of an electric machine, comprising:
a hollow shaft that has a first cooling channel for a cooling medium,
a laminated core arranged on the hollow shaft,
a balancing disc arranged on a longitudinal end side of the laminated core, and
a component of an injection molding compound/molding compound arranged between the balancing disc and the laminated core, the component comprises at least one second cooling passage open in an axial direction and communicating with the first cooling passage in the hollow shaft, and is covered in an axial direction by the balancing disc and forms an at least partially closed cooling passage.

2. The rotor according to claim 1, wherein the component is conical in shape.

3. The rotor according to claim 1, wherein:
rotor windings with winding heads on the longitudinal end side are arranged in the laminated core, wherein the winding heads are embedded in the injection molding compound/casting compound of the component, or
PSM magnets are arranged in the laminated core, wherein the PSM magnets are embedded at their longitudinal ends in the injection molding compound/casting compound of the component.

4. The rotor according to claim 1, wherein the at least one second cooling channel has a constant or variable cross-section.

5. The rotor according to claim 1, wherein:
the at least one second cooling channel is a cooling channel closed radially outward or open radially outward, and/or
the at least one second cooling channel is structured linear or curved.

6. The rotor according to claim 1, wherein a balancing disc and a component made of an injection-molded com-pound/casting compound are arranged at both longitudinal ends of the laminated core, each of the components have at least one second cooling channel that is open in the axial direction and connected to the first cooling channel in the hollow shaft, and is covered in the axial direction by the associated balancing disc.

7. The rotor according to claim 6, wherein:
an intermediate space is arranged between each of the balancing discs and the laminated core, and
at least one connecting channel is arranged between opposing intermediate spaces or between at least two second cooling channels.

8. The rotor according to claim 7, wherein the first cooling channel is connected directly to at least one second cooling channel and indirectly to at least one opposite second cooling channel via the connecting channel.

9. The rotor according to claim 7, wherein the first cooling channel is connected exclusively to the connecting channel and, via this, communicates with the at least two second cooling channels.

10. The rotor according to claim 7, wherein the connecting channel runs in the laminated core or between the laminated core and the hollow shaft.

11. The rotor according to claim 1, wherein the balancing disc is made of metal.

12. The rotor according to claim 1, wherein the injection molding compound/casting compound is made of plastic.

13. The rotor according to claim 1, wherein the component has a collar that at least partially surrounds the component on an outside.

14. An electric machine comprising:
a rotor, the rotor including:
a hollow shaft that has a first cooling channel for a cooling medium,
a laminated core arranged on the hollow shaft,
a balancing disc arranged on a longitudinal end side of the laminated core, and
a component of an injection molding compound/molding compound arranged between the balancing disc and the laminated core, the component comprises at least one second cooling passage open in an axial direction and communicating with the first cooling passage in the hollow shaft, and is covered in an axial direction by the balancing disc and forms an at least partially closed cooling passage.

15. The electric machine according to claim 14, wherein the component is conical in shape.

16. The electric machine according to claim 15, wherein the component has an axial thickness that increases radially outward.

17. The electric machine according to claim 14, wherein:
rotor windings with winding heads on the longitudinal end side are arranged in the laminated core, wherein the winding heads are embedded in the injection molding compound/casting compound of the component, or
PSM magnets are arranged in the laminated core, wherein the PSM magnets are embedded at their longitudinal ends in the injection molding compound/casting compound of the component.

18. The electric machine according to claim 14, wherein the at least one second cooling channel has a constant or variable cross-section.

19. The electric machine according to claim 14, wherein:
the at least one second cooling channel is a cooling channel closed radially outward or open radially outward, and/or
the at least one second cooling channel is structured linear or curved.

20. The electric machine according to claim 14, wherein the component has a collar that at least partially surrounds the component on an outside.
